(19) United States
(12) Patent Application Publication
(10) Pub. No.: US 2024/0039596 A1
(43) Pub. Date: Feb. 1, 2024

(54) BEAMFORMING INDICATION TECHNIQUES

(71) Applicant: ZTE Corporation, Shenzhen (CN)

(72) Inventors: Wei CAO, Shenzhen (CN); Nan ZHANG, Shenzhen (CN); Jianwu DOU, Shenzhen (CN); Kaibo TIAN, Shenzhen (CN)

(21) Appl. No.: 18/486,917

(22) Filed: Oct. 13, 2023

Related U.S. Application Data
(63) Continuation of application No. PCT/CN2021/104464, filed on Jul. 5, 2021.

(51) Int. Cl. H04B 7/06

(52) U.S. Cl. CPC H04B 7/0617; H04B 7/0632; H04B 7/04013

(57) ABSTRACT

Techniques are described to indicate beamforming related information to a smart node that forwards signals to a base station (BS) and/or a user equipment (UE). An example wireless communication method includes receiving, by a first network node from a second network node, a configuration information that indicates information about a number of spatial settings configured for the first network node, where each of the number of spatial settings corresponds to a spatial domain filter used by the first network node to communicate with one or more communication nodes.

### CROSS REFERENCE TO RELATED APPLICATIONS

This patent document is a continuation of and claims benefit of priority to International Patent Application No. PCT/CN2021/104464, filed on Jul. 5, 2021. The entire content of the before-mentioned patent application is incorporated by reference as part of the disclosure of this application.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for indicating beamforming related information to a smart node that forwards signals to a base station (BS) and/or a user equipment (UE).

A first example wireless communication method includes receiving, by a first network node from a second network node, a configuration information that indicates information about a number of beams configured for the first network node; and performing, by the first network node, communication with one or more communication nodes by configuring the number of beams according to the configuration information.

In some embodiments, the performing the communication includes transmitting to a communication node information using a beam from the number of beams, and the information is received by the first network node from the second network node prior to the transmitting. In some embodiments, the performing the communication includes receiving from a communication node information using a beam from the number of beams, and the first network node sends to the second network node the information received from the communication node. In some embodiments, the first network node transmits the maximum number of beams supported by the first network node to the second network node prior to the receiving the configuration information. In some embodiments, the configuration information includes a bitmap indicating the number of beams to be used by the first network node to send the information to the communication node, and each bit in the bitmap indicates that a corresponding beam is either enabled or disabled to send the information. In some embodiments, the number of beams is configured by a base station (BS) or an operation, administration, and management (OAM) node.

A second example wireless communication method includes receiving, by a communication node from a second network node, a configuration information that indicates a number of beams that are configured for a first network node; and receiving, by the communication node, information from the first network node on a beam from the number of beams, wherein the information is received by the communication node from the second network node via the first network node.

In some embodiments, the configuration information includes a bitmap that includes one or more bits, wherein each bit corresponds to one reference signal, and wherein each bit indicates to the communication node whether a reference signal is to be received by the communication node from the second network node via the first network node. In some embodiments, the configuration information indicates the number of beams associated with each of one or more reference signals that are to be received by the communication node from the second network node via the first network node. In some embodiments, the configuration information is received in a system information (SI).

A third example wireless communication method includes receiving, by a communication node from a second network node, a configuration information that indicates a forwarding gap when a first network node does not send to the communication node information from the second network node, wherein the forwarding gap indicates a length of time when the communication node receives one or more reference signals from the second network node and does not receive the one or more reference signals from the first network node; and receiving, by the communication node, the one or more reference signals from the second network node during the forwarding gap and the one or more reference signals from the first network node during a time other than the forwarding gap.

In some embodiments, the configuration information includes a bitmap that includes one or more bits, wherein each bit corresponds to one reference signal, and a value of each bit indicates whether a reference signal is to be received by the communication node from the second network node via the first network node. In some embodiments, the configuration information includes a value for the forwarding gap associated with each of the one or more reference signals that are not to be received by the communication node from the second network node during the forwarding gap. In some embodiments, the configuration information is received in a system information (SI). In some embodiments, the one or more reference signals includes one or more synchronization signal blocks (SSBs).

A fourth example wireless communication method includes receiving, by a first network node from a second network node, a configuration information that includes: (1) an ordered sequence of a plurality of beams to be used by the first network node, (2) a plurality of time lengths corresponding to the plurality of beams, wherein each time length is associated with one beam, and (3) a valid time interval that indicates a time length when the first network node performs transmissions using the ordered sequence of the plurality of beams and the plurality of time lengths; and performing, by the first network node, the transmissions using the plurality of beams according to the configuration information. In some embodiments, the first network node repeats the transmissions using the plurality of beams in the time length.

A fifth example wireless communication method includes receiving, by a first network node from a second network node, a configuration information that includes: (1) one or more beams to be used by the first network node, and (2) a time length indication that indicates a time length when the first network node performs transmissions using the one or more beams; and performing, by the first network node, the transmissions using the one or more beams during the time length.

A sixth example wireless communication method includes receiving, by a first network node from a second network node, a beam sweeping period that indicates a length of time when the first network node is to perform a transmission using beam sweeping; and performing, by the first network node, the beam sweeping operation during the beam sweeping period by using a plurality of controllable reflecting elements of the first network node. In some embodiments, the beam sweeping period is configured by a base station (BS) or an operation, administration, and management (OAM) node.

A seventh example wireless communication method includes receiving, by a first network node from a second network node, a report that indicates a quality of signal transmission performed by the first network node over a beam sweeping period, wherein the beam sweeping period indicates a length of time when the first network node performs transmissions using a plurality of controllable reflecting elements; and performing, by the first network node, the transmission using the plurality of controllable reflecting elements according to the report.

In some embodiments, the report indicates the quality of signal transmission for each of a plurality of time units within the beam sweeping period. In some embodiments, the report indicates that the quality of signal transmission is high during a number of time interval, wherein each time interval is identified by a first time when a time interval starts and a second time when the time interval ends. In some embodiments, the report indicates that the quality of signal transmission is high during a number of time interval, wherein each time interval is identified by a time when a time interval starts and a length of time of the time interval. In some embodiments, the second network node includes a base station (BS), and wherein the communication node includes a user equipment (UE).

An eighth example wireless communication method includes receiving, by a first network node from a second network node, a configuration information that indicates information about a number of spatial settings configured for the first network node, where each of the number of spatial settings corresponds to a spatial domain filter used by the first network node to communicate with one or more communication nodes.

In some embodiments, the first network node transmits a maximum number of spatial settings supported by the first network node to the second network node prior to the receiving the configuration information. In some embodiments, the configuration information includes a bitmap indicating the number of spatial settings to be used by the first network node to communicate with a communication node, and each bit in the bitmap indicates that a corresponding spatial setting is either enabled or disabled in communication with the communication node. In some embodiments, the number of spatial settings is configured by a base station (BS) or an operation, administration, and management (OAM) node. In some embodiments, the method further comprises performing, by the first network node, communication with the one or more communication nodes by using a spatial setting from the number of spatial settings according to the configuration information. In some embodiments, the performing the communication includes transmitting to a communication node information using the spatial setting, and the information is received by the first network node from the second network node prior to the transmitting. In some embodiments, the performing the communication includes receiving from a communication node information using the spatial setting, and the first network node sends to the second network node the information received from the communication node.

A ninth example wireless communication method includes receiving, by a communication node from a second network node, a configuration information that include: a bitmap corresponding to one or more reference signals, a number of spatial settings that are configured for a first network node, and a number of forwarding gaps associated with one or more reference signal.

In some embodiments, the bitmap includes one or more bits, wherein each bit corresponds to one reference signal, and wherein each bit indicates to the communication node whether a reference signal is to be received by the communication node from the second network node via the first network node. In some embodiments, the configuration information indicates the number of spatial settings associated with each of the one or more reference signals that are to be received by the communication node from the second network node via the first network node. In some embodiments, the configuration information indicates a forwarding gap when a first network node does not send to the communication node information from the second network node, the forwarding gap indicates a length of time when the communication node receives the one or more reference signals from the second network node and does not receive the one or more reference signals from the first network node, and the method comprises receiving, by the communication node, the one or more reference signals from the second network node during the forwarding gap and the one or more reference signals from the first network node during a time other than the forwarding gap.

In some embodiments, the configuration information includes a value for the forwarding gap associated with each of the one or more reference signals that are not to be received by the communication node from the second network node during the forwarding gap. In some embodiments, the configuration information is received in a system information (SI). In some embodiments, the method further comprises receiving, by the communication node, information from the first network node using a spatial setting from the number of spatial settings, wherein the information is received by the communication node from the second network node via the first network node. In some embodiments, the one or more reference signals includes one or more synchronization signal blocks (SSBs).

A tenth example wireless communication method includes receiving, by a first network node from a second network node, an indication information that includes any one or more of the following: (1) an ordered sequence of a plurality of spatial settings to be used by the first network node, and a plurality of time lengths corresponding to the plurality of spatial settings, wherein each time length is associated with one spatial settings, (2) a valid time interval that indicates a time length when the first network node performs transmissions using the ordered sequence of the plurality of spatial settings and the plurality of time lengths; and performing, by the first network node, the transmissions using the plurality of spatial settings according to the indication information, wherein the first network node repeats the transmissions using the plurality of spatial settings in the time length in response to receiving the valid time interval.

An eleventh example wireless communication method includes receiving, by a first network node from a second network node, an indication information that includes: (1) a spatial setting sweeping period that indicates a length of time when the first network node is to perform a transmission using spatial setting sweeping, wherein the spatial setting sweeping period indicates a length of time when the first network node performs transmissions using a plurality of controllable reflecting elements, and (2) a report that indicates a quality of signal transmission performed by the first network node over the spatial setting sweeping period; and performing, by the first network node, the transmission using the plurality of controllable reflecting elements according to the report.

In some embodiments, the spatial setting sweeping period is configured by a base station (BS) or an operation, administration, and management (OAM) node. In some embodiments, the report indicates the quality of signal transmission for each of a plurality of time units within the spatial setting sweeping period. In some embodiments, the report indicates that the quality of signal transmission is high during a number of time interval, wherein each time interval is identified by a first time when a time interval starts and a second time when the time interval ends. In some embodiments, the report indicates that the quality of signal transmission is high during a number of time interval, wherein each time interval is identified by a time when a time interval starts and a length of time of the time interval. In some embodiments, the second network node includes a base station (BS), and wherein the communication node includes a user equipment (UE).

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIGS. 1A and 1B show examples of use cases for a smart node.

FIGS. 2A and 2B show example configurations of the smart node's beams.

FIG. 3 shows a base station (BS) indicating Nₚₒᵣₜ^{reporter} and the associated synchronization signal blocks (SSBs) to a user equipment (UE).

FIG. 4 shows an example scenario of a two-path propagation model.

FIG. 5 shows illustration of received reference signal receive power (RSRP) during a smart node's forwarding period.

FIG. 6 shows an exemplary block diagram of a hardware platform that may be a part of a network node, a smart node, or a user equipment.

FIG. 7 shows an example of wireless communication including a base station (BS) and user equipment (UE) based on some implementations of the disclosed technology.

FIGS. 8 to 18 show exemplary flowcharts for a wireless communication method.

### DETAILED DESCRIPTION

With the development of the new radio (NR) access technologies (e.g., 5G), a broad range of use cases including enhanced mobile broadband, massive machine-type communications (MTC), critical MTC, etc., can be realized. To support at least these use cases, more stringent requirements such as ultra-high data rate, energy efficiency, global coverage and connectivity, as well as extremely high reliability and low latency should be met. Higher frequency bands including millimeter wave (mmWave) and even terahertz have been used in NR to utilize their large and available bandwidth. However, more active nodes and more antennas are needed to compensate for the higher propagation loss for higher frequency bands, which means high hardware cost/power consumption and severe interference.

To at least improve coverage with low cost and/or improve data rate with extra diversity, a smart node can be used in the NR network. The BS transmits control information to the smart node to control the signal forwarding. The smart node can forward the signal received from the BS to a UE or a UE group. The smart node can also forward the signal received from a UE or a UE group to the BS. The signal forwarding by the smart node can be switched on/off. The smart node can include a planar surface with a large number of passive reflecting elements (e.g., a reconfigurable intelligent surface (RIS)) or an amplifier plus a forwarding bent-pipe device (e.g., a bent-pipe relay or bent-pipe repeater). The smart node can induce a controllable amplitude and/or phase change to the incident signal using the control information from the BS. Therefore the spatial direction used for the signal forwarding by the smart node can be controlled by the BS.

In this patent document, the control information transmitted on the interface between a BS and a smart node, the control information transmitted on the interface between a BS and a UE and the related beam management procedure is proposed. A beam used for communication can be referred to as a spatial setting or the beam used for communication can refer to a spatial setting, e.g., a spatial domain filter applied at a transmitter or a receiver. A beam can be associated to one or more reference signal, e.g., SSB, CSI-RS, SRS, DMRS. In this patent document, at least following technical problems and corresponding technical solutions/methods have been presented.
Embodiment 1: Step based beamforming indication
   Case 1—BS to smart node: A BS configures a smart node with a number of beams used in forwarding
   Case 2—BS to UEs: The BS indicates to UE(s) the smart node's beams number and the associated SSB
   Case 3—BS to UEs: The BS indicates to the UE(s) a forwarding gap and a L1 filtering coefficient
   Case 4—BS to smart node: The BS indicates to the smart node a beam used for signal forwarding to the UE(s)
Embodiment 2: Stepless beamforming indication
   Case 1—BS to smart node: A BS configures a smart node with a beam sweeping period
   Case 2—BS to smart node: The BS indicates to the smart node forwarding quality during the beam sweeping period

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction and Example Scenarios

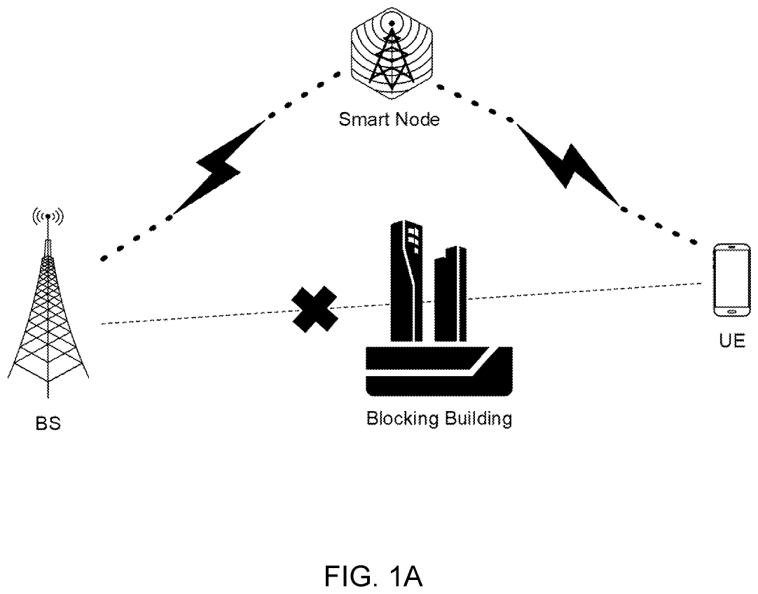

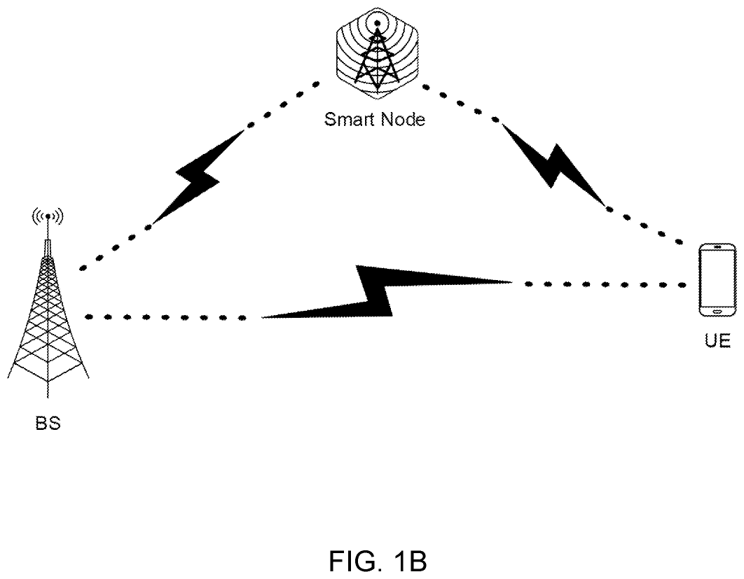

Some examples of major use cases of a smart node are illustrated in FIGS. 1A and 1B. In FIG. 1A, the smart node can improve the coverage by adding a new reflecting path. In FIG. 1B, the smart node can improve the data rate by adding extra multipath diversity.

The smart node can include a planar surface with a large number of passive reflecting elements (e.g., a reconfigurable intelligent surface (RIS)) or an amplifier plus a forwarding bent-pipe device (e.g., a bent-pipe relay or bent-pipe repeater). The smart node can induce a controllable amplitude and/or phase change to the incident signal using the control information from the BS. Therefore, the spatial direction used for the signal forwarding by the smart node can be controlled by the BS.

Step based beamforming indication: For a smart node with a number of beams (e.g., an amplifier plus a forwarding bent-pipe device with a few beams of different and fixed directions), the BS can indicate to the smart node which smart node's beam to be used in forwarding information to UE(s).

Stepless beamforming indication: For a smart node with a large number of reflecting elements, it is difficult for a BS to control each reflecting element of the smart node. Thus, in some embodiments, the BS can configure a smart node with a beam sweeping period. The smart node changes the amplitude and/or phase of each reflecting element by itself to perform stepless beam sweeping in its signal forwarding during the beam sweeping period. The BS indicates the signal forwarding quality to the smart node. The smart node changes the amplitude and/or phase of each reflecting element by itself to adjust stepless beam sweeping in its signal forwarding using the signal forwarding quality indicated by the BS.

In an NR system, initial downlink (DL) synchronization can be carried out by the smart node using synchronization signal block (SSB). From the SSB, following information can be obtained at the smart node's PHY layer.
1. The base station's (BS's) frequency band
2. The subcarrier spacing (SCS) of SSB
3. The SSB's symbol length, which is calculated as 1/(SSB's SCS)
4. The SSB's slot length, which is calculated as 15/(SSB's SCS).
5. The number of SSBs, Lₘₐₓ
6. The SSB index
7. The frame index lower 4 bits, e.g., per 160 ms
8. The half frame indication, e.g., per 5 ms

To facilitate UE(s) specific beamforming by the smart node, any one or more of the following information exchange can be beneficial:
1. The smart node's beams measurement report
2. The smart node's beam used in forwarding information to UE(s)
3. The signal forwarding quality

### II. Embodiment 1 Step Based Beamforming Indication

To effectively forward the BS's signal, a smart node is generally deployed in a location with line of sight (LOS) path to the BS. The smart node's location can be generally fixed. If a portable smart node is used, its location is generally semi-fixed (e.g., fixed in a given time interval). Similar to a typical BS, the smart node can generate a few beams with fixed direction. If the number of beams supported by the smart node is N_{port,max}^{node}, the smart node can forward signal using different N_{port,max}^{node} beams at most. Similar to a typical BS, the number of beams actually deployed may be Nₚₒᵣₜ^{node} (with Nₚₒᵣₜ^{node}≤N_{port,max}^{node}), which can be implemented by adjustable amplitude and/or phase of each radio frequency (RF) units in the smart node.

### a. Case 1—BS to Smart Node: ABS Configures a Smart Node With a Number of Beams Used in Forwarding

The number of beams used by the smart node, called Nₚₒᵣₜ^{node}, can be configured by the BS or Operation, Administration, and Management (OAM). In some embodiments, the number of beams used by the smart node (Nₚₒᵣₜ^{node}) can be configured by the BS or OAM, if the surrounding environment of the smart node is known in its deployment. The BS or OAM node (or OAM device) transmits the number of beams to the smart node.

The smart node supports a maximum of N_{port,max}^{node} beams. There are following options to let the BS know this capability.
1. The smart node reports N_{port,max}^{node} to the BS, or
2. The N_{port,max}^{node} of the smart node is sent to the BS by the OAM.

The BS configures the smart node with the number of beams used in forwarding. There are following options to let the smart node know how many beams and which beams to be used to forward signal.
1. The BS indicates Nₚₒᵣₜ^{node} to the smart node, with Nₚₒᵣₜ^{node}≤N_{port,max}^{node}.
2. The BS configures Nₚₒᵣₜ^{node} to the smart node via OAM.

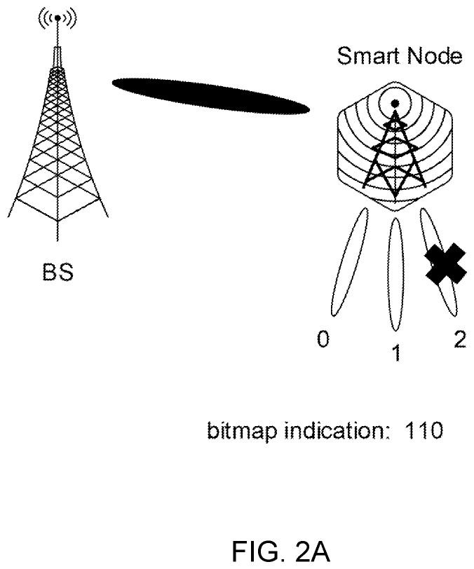

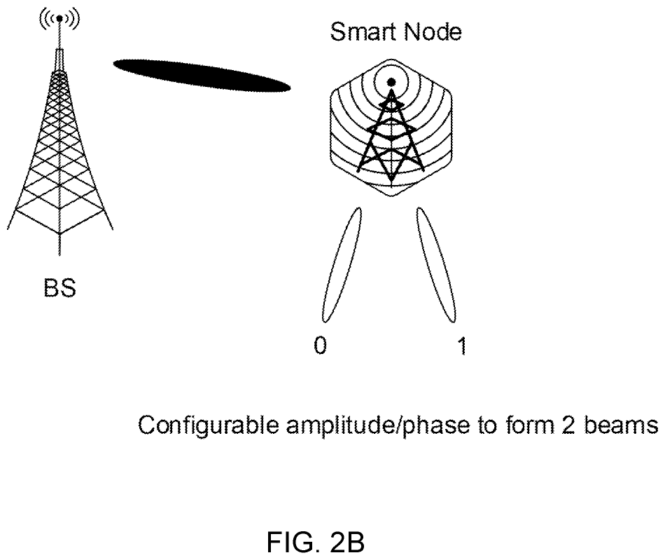

In some embodiments, there are following options to configure the smart node's beams, which are illustrate in FIGS. 2A and 2B.
1, The BS indicates a list of beam indexes to the smart node. For example, a bitmap can be used as shown in FIG. 2A. The smart node supports N_{port,max}^{node} (=3 in this example) beams, the number of used beams Nₚₒᵣₜ^{node} (=2 in this example) is configured by the BS, which is given by the number of 1s in the bit map. For example, as shown in FIG. 2A, the BS can send a bitmap of 110 to the smart node indicating that beam 0 and beam 1 are enabled and that beam 2 is disabled. In some embodiments, the beam width of the smart node is not changed by the BS. In such embodiments, the BS can only enable/disable the beams of the smart node.
2. The BS configures the amplitude/phase of the smart node to form Nₚₒᵣₜ^{node} beams. The beam width of the smart node is controlled by the BS as shown in FIG. 2B. For example, the BS sends to the smart node information related to amplitude and phase of each of one or more beams of the smart node (e.g., beam 0 and beam 1 shown in FIG. 2B) so that the smart node can configure the amplitude and phase of the one or more beams.

Based on the configuration information provided by the BS (e.g., the bitmap of one or more beams or the amplitude/phase of each of one or more beams), the smart node can perform transmission operations using a beam from the one or more beams to send information to the UE or the BS, where the information is received by the smart node from the BS or the UE, respectively.

### b. Case 2—BS to UEs: The BS Indicates to UE(s) the Smart Node's Beams Number and the Associated SSB

Though the smart node should be transparent to UEs, it is beneficial to indicate Nₚₒᵣₜ^{node} of a smart node and the associated SSB by the BS. With this information, the UEs' measurement can be enhanced to facilitate more accurate beam management. For example, the BS can determine the best beam of a smart node used for signal forwarding to UE(s). And the BS can indicate to the smart node to use corresponding beam in its signal forwarding.

After successful connection between the BS and the smart node, the best SSB (with an index of I_{SSB}) selected by the smart node is known by the BS and the smart node. The smart node uses Nₚₒᵣₜ^{node} beams to forward the BS's signal. From the viewpoint of a UE in the coverage of the smart node, the BS's SSB I_{SSB} is forwarded by the smart node with multiple beams in a TDM manner. Therefore, the signal quality of the SSB I_{SSB} may vary with the beam sweeping period of the smart node. At the same time, the UE may directly receive some SSBs from the BS.

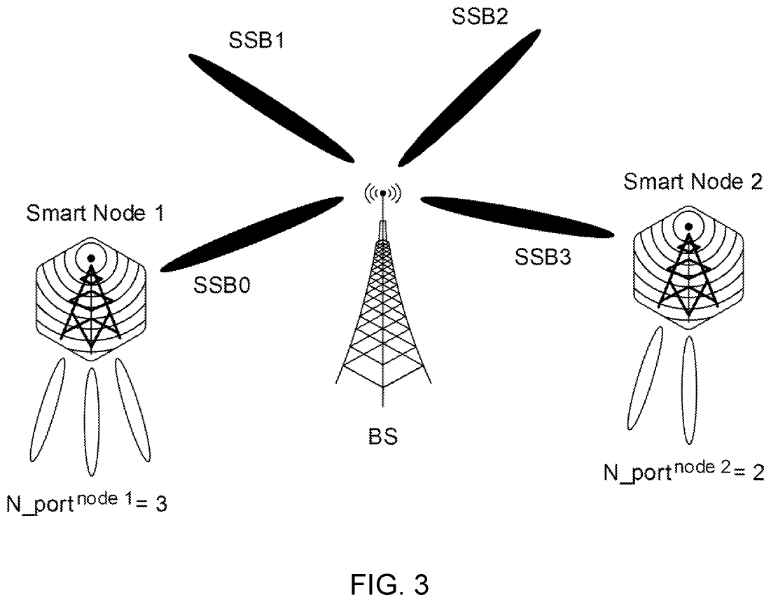

To help the UE measure the SSBs, the BS can include the Nₚₒᵣₜ^{node} for each of one or more smart nodes in system information (SI) sent to the UEs. FIG. 3 shows an example scenario where the Nₚₒᵣₜ^{node} is included in the SI with the associated SSB(s). In addition, the associated SSB index I_{SSB} can also be indicated in the SI. For example, it is possible to have a bitmap for each SSB of the BS so that, for example, the number of bits in the bitmap corresponds to the number of SSBs. If the SSB index I_{SSB} has been selected by a smart node, the bit corresponding to this SSB can be set to 1 by the BS. The bitmap sent by the BS to the UEs using SI informs the UEs that the signal quality (e.g., RSRP) of the SSB with a bit value of 1 received by the UE is impacted by Nₚₒᵣₜ^{node}. A sequence of Nₚₒᵣₜ^{node} for each SSB with a bit value of 1 in the bitmap can be included in the SI, where a bit value of 1 indicates that the SSB is to be forwarded by a smart node. In some embodiments, based on the information indicated in the bitmap, the UEs can perform beam measurement for (1) the smart node's beam, and for (2) the BS's beam. For example, for each SSB with a bit value of 1, a Nₚₒᵣₜ^{node} value is included in the SI. For example, for SSB0, the SI may include a value of 3 associated with SSB0, where the value of 3 indicates that there are three beams associated with the smart node that forwards SSB0 (N_port^{node1}=3). In FIG. 3, a bitmap for SSBs of 1001 can be included in SI, which indicates that SSB0 and SSB3 are forwarded by smart nodes; the values for N_port^{node1} (e.g., 3) and N_port^{node2} (e.g., 2) can be included in SI for SSB0 and SSB3, respectively; and/or the bitmap for SSBs can be used as a flag for the existence or presence of a smart node (e.g., N_port^{index}).

Based on the configuration information provided by the BS (e.g., the bitmap of one or more SSBs and/or Nₚₒᵣₜ^{node}), the UE can receive information from the BS via the smart node.

### c. Case 3—BS to UEs: The BS Indicates to the UE(s) a Forwarding Gap and a L1 Filtering Coefficient

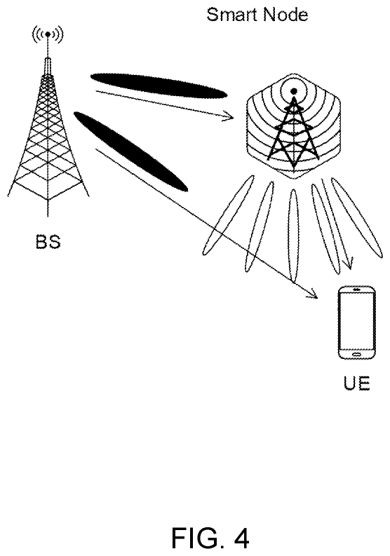

To facilitate UE(s) specific beamforming, the BS needs to know the best beam used by a UE, which may be used by the UE to receive information directly from the BS's beam or via a smart node's beam. As illustrated in FIG. 4, the UE has a 2-path DL channel from the BS and the smart node, respectively.

### c.(1). The BS indicates the Forwarding Gap N_{gap}^{node} in SI

Similar to beam sweeping used by the BS's SSBs, the smart node forwards the BS's SSBs using its own beams in a TDM beam sweeping manner. The periodicity of a BS's SSBs can be obtained by the smart node from the BS (e.g., via SIB1->ServingCellConfigCommonSIB->ssb-periodicityServingCell). If the smart node has Nₚₒᵣₜ^{node} beams, the UEs can determine that the periodicity of a forwarded SSB is (Nₚₒᵣₜ^{node}+N_{gap}^{node})*ssb-periodicityServingCell. The parameter N_{gap}^{node} refers to the forwarding gap of the smart node. During the forwarding gap, in some embodiments, the smart node does not forward the SSB that the smart node may receive from the BS to facilitate the direct connection (between the BS and the UE) measurement. In some embodiments, the UEs use the gap and the period to perform beam measurement and report to the BS. The BS can determine the best beam used by the UE(s) based on the report, and the BS can indicate the smart node to use the best beam to forward signal.

In some embodiments, the N_{gap}^{node} can be indicated using a length of time when SSBs are not forwarded by the smart node, where the length of time can be indicated using units of symbol(s)/slot(s)/subframe(s)/frame(s). Similar to indication of Nₚₒᵣₜ^{node}, the BS can include the N_{gap}^{node} in SI. A sequence of N_{gap}^{node} for each SSB with a bit value of 1 in the bitmap can be included in the SI, where a bit value of 1 indicates that the SSB is forwarded by a smart node. For example, for each SSB with a bit value of 1, a N_{gap}^{node} value is included in the SI.

The location of the N_{gap}^{node} forwarding gaps should be known by both the BS and the UE. A method is put the N_{gap}^{node} forwarding gaps at the beginning/end of each period of (Nₚₒᵣₜ^{node}+N_{gap}^{node})*ssb-periodicityServingCell.

### c.(2). The BS Indicates the L1 Filtering Coefficient

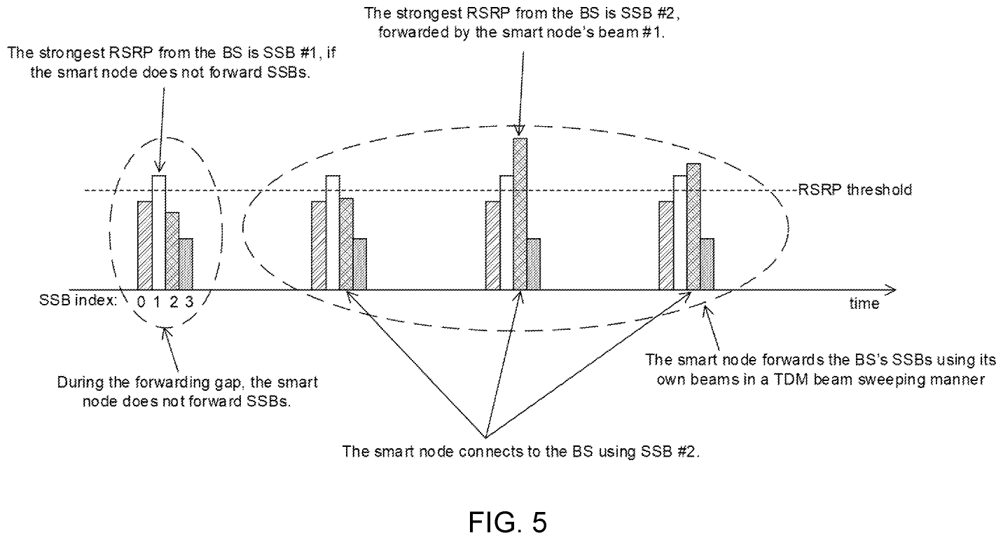

Here an example is given for better understanding.
(1) The BS's ssb-periodicityServingCell=20 ms
(2) The BS's number of SSBs=4
(3) The smart node's number of beams Nₚₒᵣₜ^{node}=3
(4) The smart node's forwarding gap N_{gap}^{node}=1
(5) For a given UE, the strongest RSRP from the BS is SSB #1, if the smart node does not forward SSBs. For this UE, the strongest RSRP from the BS is SSB #2 forwarded by the smart node's beam #1. It is observed that the periodicity of a forwarded SSB is (Nₚₒᵣₜ^{node}+N_{gap}^{node})*ssb-periodicityServingCell=(3+1)*20 ms=80 ms. The start of this 80 ms period can be the same of the MIB's 80 ms period. In one example, during this 80 ms period, the 1 forwarding gap is put at the beginning. The 3 forwarded SSBs via the smart node are put following the forwarding gap. Thus, in this example, and as shown in FIG. 5, the smart node does not perform any transmission when that the BS transmits SSBs 0 to 3 to the UE(s) during the first 20 ms, then the smart node transmits the SSBs 0 to 3 received from the BS during the 60 ms that follows the 20 ms, where the smart node transmits SSBs 0 to 3 for a total of 3 times since the number of beams Nₚₒᵣₜ^{node}=3, where each beam transmits SSBs 0 to 3.
(6) At the UE side, a L1 filtering on the RSRP should be applied to obtain long term RSRP for each non-forwarded/forwarded SSB. In the example, the RSRP of each SSB during N_{gap}^{node} forwarding gaps should be averaged, which represents the direct connection quality between the BS and the UE. The RSRP of each SSB forwarded by the smart node should be averaged per smart node's beam, which represents the connection quality between a given beam of the smart node and the UE. The L1 filtering can use the formula RSRP_{long term}(tₙ)=alpha*RSRPᵢₙₛₜₐₙₜ(tₙ)+(1−alpha)*RSRP_{long term}(tₙ₋₁). The L1 filtering coefficient alpha ranges in [0, 1], which can be a predefined value known by the UE, or a configurable parameter indicated to the UE by the BS via at least one of DCI/MAC CE/RRC signaling.
(7) For a forwarded SSB, the UE should carry out the L1 filtering for the RSRP value per smart node's beam. In the example in FIG. 5, the UE should do the L1 filtering as below:
   (i) The UE knows the SSB #1 is not the SSB used by the smart node. Therefore the RSRP of SSB #1 filtering can be carried out every 20 ms.
   (ii) The UE knows the SSB #2 is the SSB used by the smart node. Therefore the RSRP of SSB #2 filtering can be carried out every 80 ms (=20*(3+1)) for each smart node's beam.
(8) For a forwarded SSB, the UE should report the RSRP value per smart node's beam. To save signaling, a predefined threshold can be indicated by the BS via at least one of DCI/MAC CE/RRC signaling. In the example in FIG. 5, an RSRP threshold is illustrated by the red dot line. The UE should report RSRP as below:
   (i) The RSRP of SSB #1 exceeds the threshold. The UE knows it is not the SSB used by the smart node. Therefore the RSRP of SSB #1 is reported.
   (ii) The RSRP of SSB #2 on the smart node's beam #0 does not exceed the threshold. Due to the threshold restriction, the UE can use following options in the reporting:
      1) If this value is not reported, the UE can use an invalid value as a place holder in per smart node's beam's RSRP report.
      2) A bitmap for reported beams can be used to save signaling. For example, a bitmap “011” can be used in the example, which means the smart node's beam #0 does not have a reported RSRP value.
      3) The index of reported beams can be indicated together with the RSRP value. For example, {1, RSRP1, 2, RSRP2} can be reported in the example. In this case, a total number of reported beams is generally needed as well.
         Based on the configuration information provided by the BS (e.g., the N_{gap}^{node}), the UE can receive information from the BS via the smart node and/or from the BS directly.

### d. Case 4—BS to Smart Node: The BS Indicates to the Smart Node a Beam Used for Signal Forwarding to the UE(s)

The BS checks the RSRP report from a given UE. BS determines the connection type (e.g., direct connection to UE or connection via a smart node to the UE) of a UE from the measurement report received by the BS from the UE. The BS divides UEs into groups to optimize its scheduling. The BS schedules a UE or a group of UEs via a given beam of a given smart node. Different UEs or groups of UEs are served by the BS in a TDM manner.

### 1. The BS Indicates a Sequence of a Smart Node's Beams to be Used

The BS can indicate to the smart node a sequence of a smart node's beams to be used. The smart node forwards the DL signal received from the BS using its beams accordingly. Following options can be used for this indication:
(1) The indication includes:
   (i) A sequence of smart node's beam indexes to be used one by one.
   (ii) A corresponding sequence of time length indication for each smart node's beam.
   (iii) A valid time interval for the indication. During the valid time interval, the sequence of smart node's beam indexes repeats itself. The valid time interval can be:
      1) A start time+a time length
      2) A start time+an end time
      3) A predefined timer index
(2) The indication includes:
   (i) A sequence of smart node's beam index to be used one by one.
   (ii) A fixed time length indication for each smart node's beam.
   (iii) A valid time interval for the indication. During the valid time interval, the sequence of smart node's beam indexes repeats itself. The valid time interval can be:
      1) A start time+a time length
      2) A start time+an end time
      3) A predefined timer index

### 2. The BS Indicates a Smart Node's Beam to be Used

The BS can indicate a smart node's beam to be used. The smart node forwards the DL signal received from the BS using its beams accordingly. Following options can be used for this indication:
(1) The indication includes:
   (i) A smart node's beam index to be used.
   (ii) A time length indication for using this smart node's beam. The time length indication can be:
      4) A start time+a time length
      5) A start time+an end time
      6) A predefined timer index

### II. Embodiment 2 Stepless Beamforming Indication

### a. Case 1—BS to Smart Node: ABS Configures a Smart Node With a Beam Sweeping Period

The smart node can be a device comprising a large number of reflecting elements. The status of each element can be changed, including amplitude, phase and on-off. For this kind of smart node, the beam number is huge, which equals to the number of all possible combination of each element's status. It is difficult for a BS to directly indicate to the smart node a beam to be used in signal forwarding. Instead, the smart node itself can do the stepless beam sweeping during the beam sweeping period. And the BS checks the measurement reports received from UEs and determines which time interval during the stepless beam sweeping period has the best signal quality. In a general sense, step based beamforming can be a special case of the stepless beamforming.

### 1. The BS Configures the Smart Node With a Beam Sweeping Period

(1) This can be in the unit of slot/symbol determined by the reference SCS.
(2) This can be in the unit of predefined frame or subframe.
(3) This can be in the unit of absolute time unit, e.g., millisecond (ms). In some embodiments, the beam sweeping period is divisible by a slot or a symbol length.

### b. Case 2—BS To Smart Node: The BS Indicates To The Smart Node Forwarding Quality During The Beam Sweeping Period

The smart node can adjust the status of its elements. For example, the smart node can change the stepless beam direction during the beam sweeping period. And the BS checks the measurement reports from UEs and determines which time interval during the stepless beam sweeping period has the best signal quality.

The BS indicates the forwarding quality to the smart node. The forwarding quality can be derived by the BS from the measurement report from UE(s). The format of the forwarding quality can be as follows:

### 1. A Sequence of Scores For Each Time Unit

(1) The time unit for forwarding quality indication can be different from the time unit used in the stepless beam sweeping period indication. If the two time units used are different, they should be known by both the BS and the smart node.
(2) An example is given here for better understanding.
   (i) Assume the stepless beam sweeping period is 10 ms, and the time unit for forwarding quality indication is 1 ms.
   (ii) The BS indication can be: {H, H, H, L, L, L, M, M, M, H}, where H/M/L refers to high/medium/low forwarding quality, respectively.
   (iii) The BS indication can be: {1, 1, 2, 2, 3, 4, 5, 5, 5, 5}, where each number refers to a forwarding quality, where 1 can be lowest signal quality and 5 can indicate the highest signal quality.
   In some embodiments, based on the information indicated in the forwarding quality indication (or forwarding quality report), the smart node can determine how to adjust its transmission based on the forwarding quality indication. Using the example in 1. (2) (ii) above in Case 2, the smart node can use the elements' status (e.g., the amplitude and/or phase) that are associated with level of “H” to the other 6 ms time intervals with forwarding quality indication of “L” and “M”. In this way, the elements' status controlled by the smart node can be adjusted to achieve high forwarding quality in more time intervals.

### 2. A Sequence Of Time Intervals

(1) An example is given here for better understanding.
   (i) Assume the stepless beam sweeping period is 10 ms.
   (ii) The stepless beam sweeping period starts from the 10 ms frame boundary.
   (iii) The BS indication can be: {2, [2, 5], [7, 8]}, which can indicate that a high forwarding quality is observed during 2 time intervals in the stepless beam sweeping period. One is the 2 ms to 5 ms. The other is the 7 ms to 8 ms.
   (iv) The BS indication can be: {2, [2, 3], [7, 1]}, which can indicate that a high forwarding quality is observed during 2 time intervals in the stepless beam sweeping period. One starts from the 2 ms with length of 3 ms. The other starts from the 7 ms with length of 1 ms.
   Using the example in 2. (1) (iii) above in Case 2, the smart node can use the elements' status (e.g., the amplitude and/or phase) that are associated with time intervals of “2 ms to 5 ms” and “7 ms to 8 ms” to the other 6 ms not listed in the high forwarding quality indication. In this way, the elements' status controlled by the smart node can be adjusted to achieve high forwarding quality in more time intervals.

The smart node can adjust its elements' status using the forwarding quality indication from the BS. For example, the smart node can use the elements' status (e.g., the amplitude and/or phase) that are associated with the high forwarding quality time intervals in other time intervals during the stepless beam sweeping period. In this way, the smart node can adjust its beamforming direction dynamically according to the forwarding quality indication from the BS.

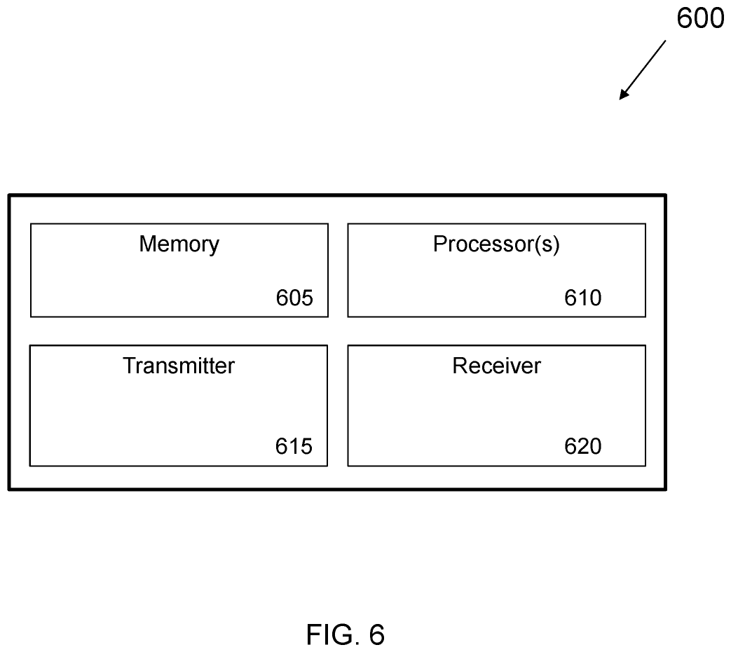

FIG. 6 shows an exemplary block diagram of a hardware platform 600 that may be a part of a network node, a smart node, or a user equipment. The hardware platform 600 includes at least one processor 610 and a memory 605 having instructions stored thereupon. The instructions upon execution by the processor 610 configure the hardware platform 600 to perform the operations described in FIGS. 1 to 5 and 7 to 18 and in the various embodiments described in this patent document. The transmitter 615 transmits or sends information or data to another node. For example, a smart node transmitter can send a message to a user equipment. The receiver 620 receives information or data transmitted or sent by another node. For example, a smart node can receive a message from a network node or a user equipment.

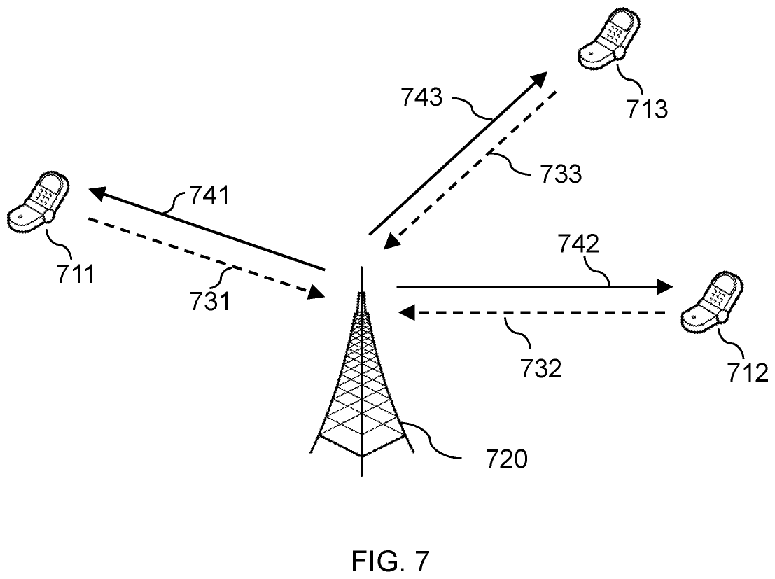

The implementations as discussed above will apply to a wireless communication. FIG. 7 shows an example of a wireless communication system (e.g., a 5G or NR cellular network) that includes a base station 720 and one or more user equipment (UE) 711, 712 and 713. In some embodiments, the UEs access the BS (e.g., the network) using a communication link to the network (sometimes called uplink direction, as depicted by dashed arrows 731, 732, 733), which then enables subsequent communication (e.g., shown in the direction from the network to the UEs, sometimes called downlink direction, shown by arrows 741, 742, 743) from the BS to the UEs. In some embodiments, the BS send information to the UEs (sometimes called downlink direction, as depicted by arrows 741, 742, 743), which then enables subsequent communication (e.g., shown in the direction from the UEs to the BS, sometimes called uplink direction, shown by dashed arrows 731, 732, 733) from the UEs to the BS. The UE may be, for example, a smartphone, a tablet, a mobile computer, a machine to machine (M2M) device, an Internet of Things (IoT) device, and so on.

The uplink and/downlink communication may be performed at last in part via a smart node through which the BS and the UEs can communicate with each other as explained in this patent document.

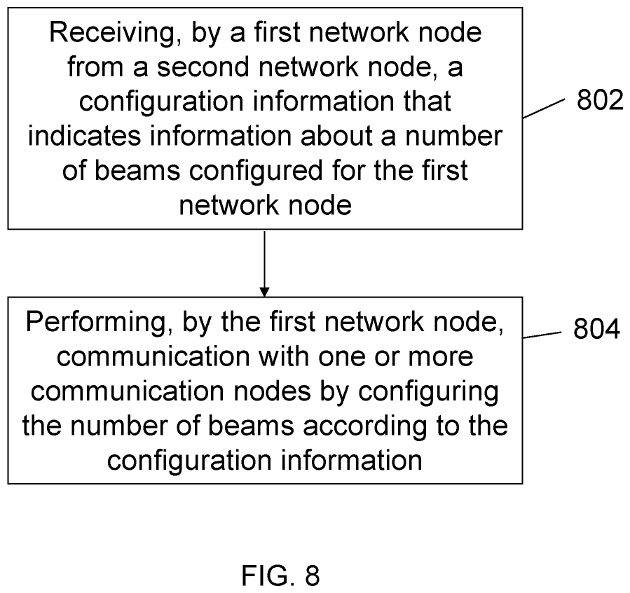

FIG. 8 shows an exemplary flowchart for a wireless communication method. Operation 802 includes receiving, by a first network node from a second network node, a configuration information that indicates information about a number of beams configured for the first network node. Operation 804 includes performing, by the first network node, communication with one or more communication nodes by configuring the number of beams according to the configuration information.

In some embodiments, the performing the communication includes transmitting to a communication node information using a beam from the number of beams, and the information is received by the first network node from the second network node prior to the transmitting. In some embodiments, the performing the communication includes receiving from a communication node information using a beam from the number of beams, and the first network node sends to the second network node the information received from the communication node. In some embodiments, the first network node transmits the maximum number of beams supported by the first network node to the second network node prior to the receiving the configuration information. In some embodiments, the configuration information includes a bitmap indicating the number of beams to be used by the first network node to send the information to the communication node, and each bit in the bitmap indicates that a corresponding beam is either enabled or disabled to send the information. In some embodiments, the number of beams is configured by a base station (BS) or an operation, administration, and management (OAM) node.

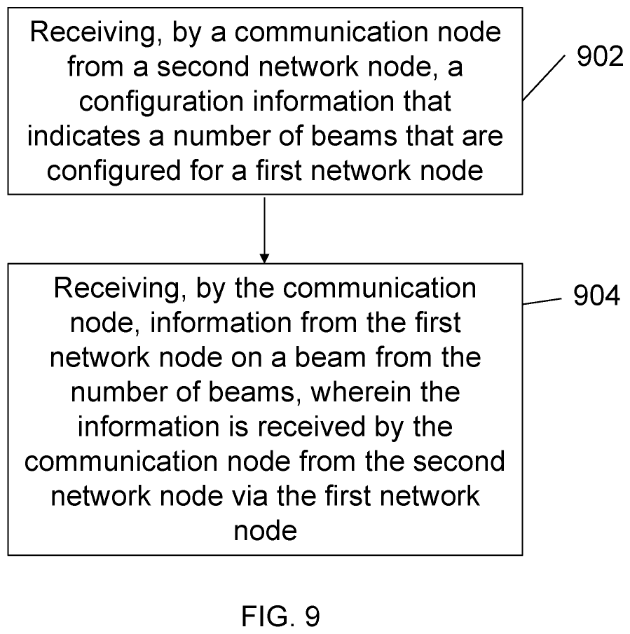

FIG. 9 shows an exemplary flowchart for a wireless communication method. Operation 902 includes receiving, by a communication node from a second network node, a configuration information that indicates a number of beams that are configured for a first network node. Operation 904 includes receiving, by the communication node, information from the first network node on a beam from the number of beams, wherein the information is received by the communication node from the second network node via the first network node.

In some embodiments, the configuration information includes a bitmap that includes one or more bits, wherein each bit corresponds to one reference signal, and wherein each bit indicates to the communication node whether a reference signal is to be received by the communication node from the second network node via the first network node. In some embodiments, the configuration information indicates the number of beams associated with each of one or more reference signals that are to be received by the communication node from the second network node via the first network node. In some embodiments, the configuration information is received in a system information (SI).

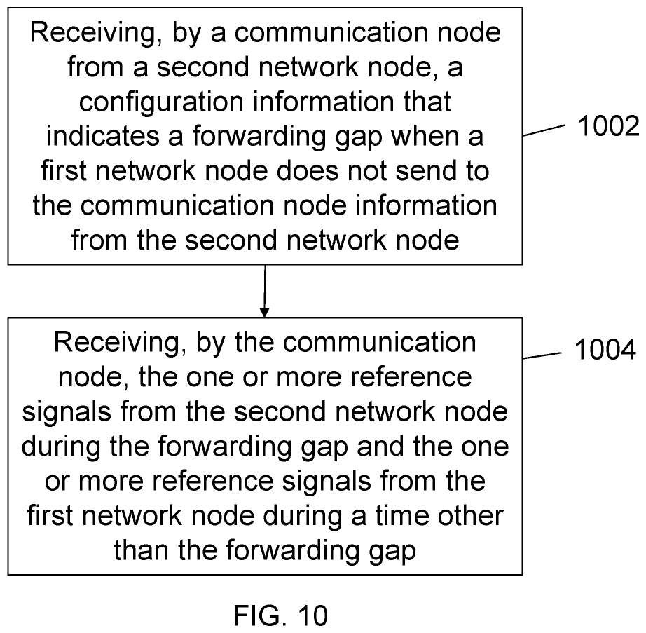

FIG. 10 shows an exemplary flowchart for a wireless communication method. Operation 1002 includes receiving, by a communication node from a second network node, a configuration information that indicates a forwarding gap when a first network node does not send to the communication node information from the second network node, wherein the forwarding gap indicates a length of time when the communication node receives one or more reference signals from the second network node and does not receive the one or more reference signals from the first network node. Operation 1004 includes receiving, by the communication node, the one or more reference signals from the second network node during the forwarding gap and the one or more reference signals from the first network node during a time other than the forwarding gap.

In some embodiments, the configuration information includes a bitmap that includes one or more bits, wherein each bit corresponds to one reference signal, and a value of each bit indicates whether a reference signal is to be received by the communication node from the second network node via the first network node. In some embodiments, the configuration information includes a value for the forwarding gap associated with each of the one or more reference signals that are not to be received by the communication node from the second network node during the forwarding gap. In some embodiments, the configuration information is received in a system information (SI). In some embodiments, the one or more reference signals includes one or more synchronization signal blocks (SSBs).

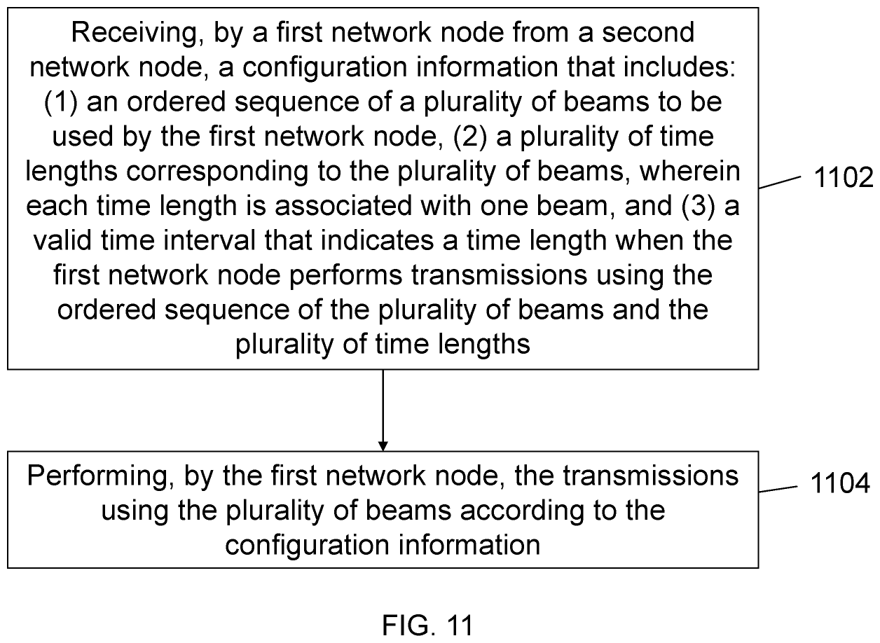

FIG. 11 shows an exemplary flowchart for a wireless communication method. Operation 1102 includes receiving, by a first network node from a second network node, a configuration information that includes: (1) an ordered sequence of a plurality of beams to be used by the first network node, (2) a plurality of time lengths corresponding to the plurality of beams, wherein each time length is associated with one beam, and (3) a valid time interval that indicates a time length when the first network node performs transmissions using the ordered sequence of the plurality of beams and the plurality of time lengths. Operation 1104 includes performing, by the first network node, the transmissions using the plurality of beams according to the configuration information. In some embodiments, the first network node repeats the transmissions using the plurality of beams in the time length.

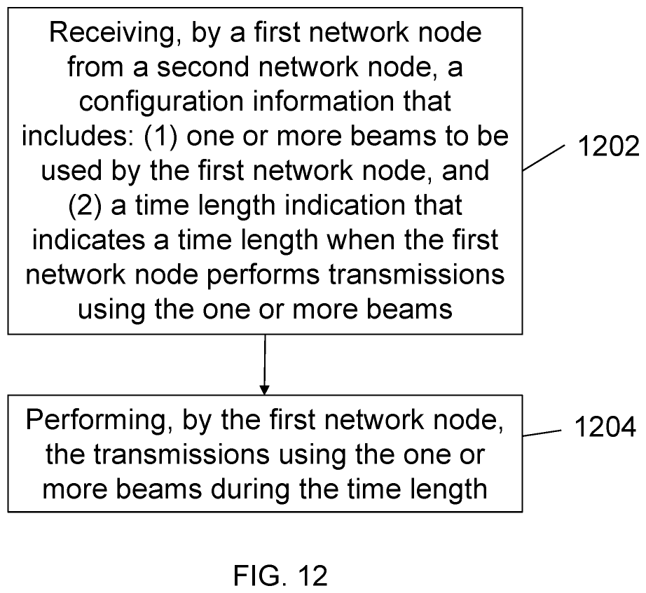

FIG. 12 shows an exemplary flowchart for a wireless communication method. Operation 1202 includes receiving, by a first network node from a second network node, a configuration information that includes: (1) one or more beams to be used by the first network node, and (2) a time length indication that indicates a time length when the first network node performs transmissions using the one or more beams. Operation 1204 includes performing, by the first network node, the transmissions using the one or more beams during the time length.

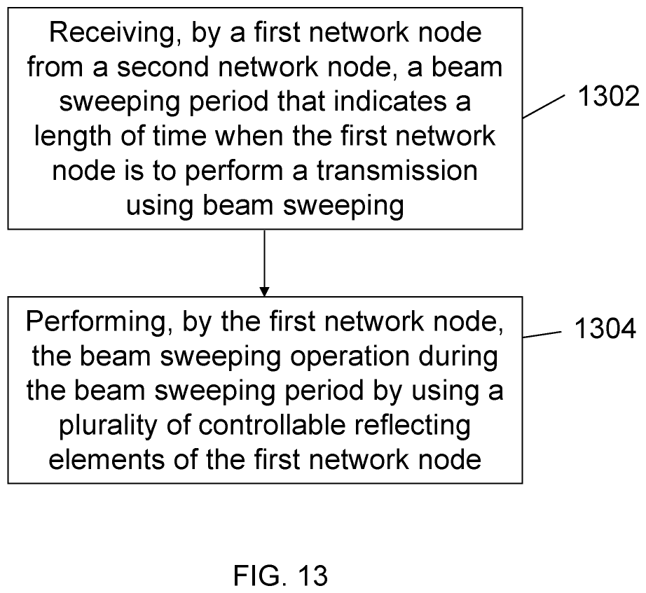

FIG. 13 shows an exemplary flowchart for a wireless communication method. Operation 1302 includes receiving, by a first network node from a second network node, a beam sweeping period that indicates a length of time when the first network node is to perform a transmission using beam sweeping. Operation 1304 includes performing, by the first network node, the beam sweeping operation during the beam sweeping period by using a plurality of controllable reflecting elements of the first network node. In some embodiments, the beam sweeping period is configured by a base station (BS) or an operation, administration, and management (OAM) node.

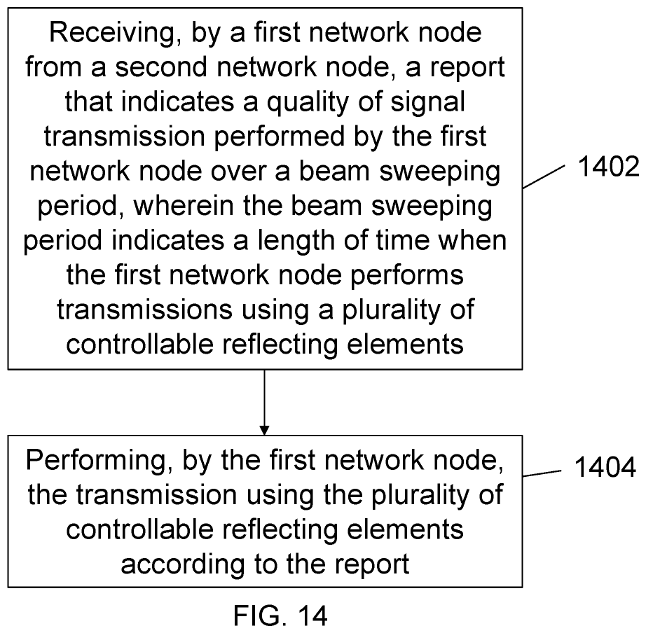

FIG. 14 shows an exemplary flowchart for a wireless communication method. Operation 1402 includes receiving, by a first network node from a second network node, a report that indicates a quality of signal transmission performed by the first network node over a beam sweeping period, wherein the beam sweeping period indicates a length of time when the first network node performs transmissions using a plurality of controllable reflecting elements. Operation 1404 includes performing, by the first network node, the transmission using the plurality of controllable reflecting elements according to the report.

In some embodiments, the report indicates the quality of signal transmission for each of a plurality of time units within the beam sweeping period. In some embodiments, the report indicates that the quality of signal transmission is high during a number of time interval, wherein each time interval is identified by a first time when a time interval starts and a second time when the time interval ends. In some embodiments, the report indicates that the quality of signal transmission is high during a number of time interval, wherein each time interval is identified by a time when a time interval starts and a length of time of the time interval. In some embodiments, the second network node includes a base station (BS), and wherein the communication node includes a user equipment (UE).

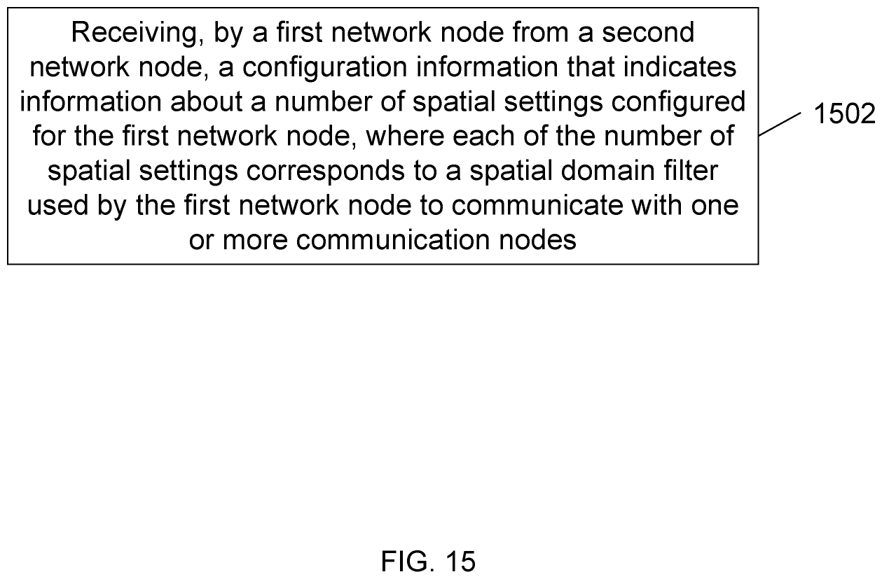

FIG. 15 shows an exemplary flowchart for a wireless communication method. Operation 1502 includes receiving, by a first network node from a second network node, a configuration information that indicates information about a number of spatial settings configured for the first network node, where each of the number of spatial settings corresponds to a spatial domain filter used by the first network node to communicate with one or more communication nodes.

In some embodiments, the first network node transmits a maximum number of spatial settings supported by the first network node to the second network node prior to the receiving the configuration information. In some embodiments, the configuration information includes a bitmap indicating the number of spatial settings to be used by the first network node to communicate with a communication node, and each bit in the bitmap indicates that a corresponding spatial setting is either enabled or disabled in communication with the communication node. In some embodiments, the number of spatial settings is configured by a base station (BS) or an operation, administration, and management (OAM) node. In some embodiments, the method further comprises performing, by the first network node, communication with the one or more communication nodes by using a spatial setting from the number of spatial settings according to the configuration information. In some embodiments, the performing the communication includes transmitting to a communication node information using the spatial setting, and the information is received by the first network node from the second network node prior to the transmitting. In some embodiments, the performing the communication includes receiving from a communication node information using the spatial setting, and the first network node sends to the second network node the information received from the communication node.

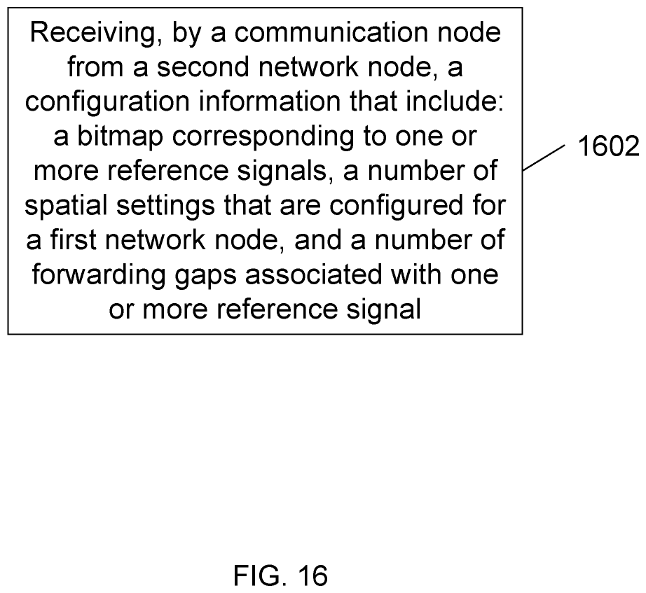

FIG. 16 shows an exemplary flowchart for a wireless communication method. Operation 1602 includes receiving, by a communication node from a second network node, a configuration information that include: a bitmap corresponding to one or more reference signals, a number of spatial settings that are configured for a first network node, and a number of forwarding gaps associated with one or more reference signal.

In some embodiments, the bitmap includes one or more bits, wherein each bit corresponds to one reference signal, and wherein each bit indicates to the communication node whether a reference signal is to be received by the communication node from the second network node via the first network node. In some embodiments, the configuration information indicates the number of spatial settings associated with each of the one or more reference signals that are to be received by the communication node from the second network node via the first network node. In some embodiments, the configuration information indicates a forwarding gap when a first network node does not send to the communication node information from the second network node, the forwarding gap indicates a length of time when the communication node receives the one or more reference signals from the second network node and does not receive the one or more reference signals from the first network node, and the method comprises receiving, by the communication node, the one or more reference signals from the second network node during the forwarding gap and the one or more reference signals from the first network node during a time other than the forwarding gap.

In some embodiments, the configuration information includes a value for the forwarding gap associated with each of the one or more reference signals that are not to be received by the communication node from the second network node during the forwarding gap. In some embodiments, the configuration information is received in a system information (SI). In some embodiments, the method further comprises receiving, by the communication node, information from the first network node using a spatial setting from the number of spatial settings, wherein the information is received by the communication node from the second network node via the first network node. In some embodiments, the one or more reference signals includes one or more synchronization signal blocks (SSBs).

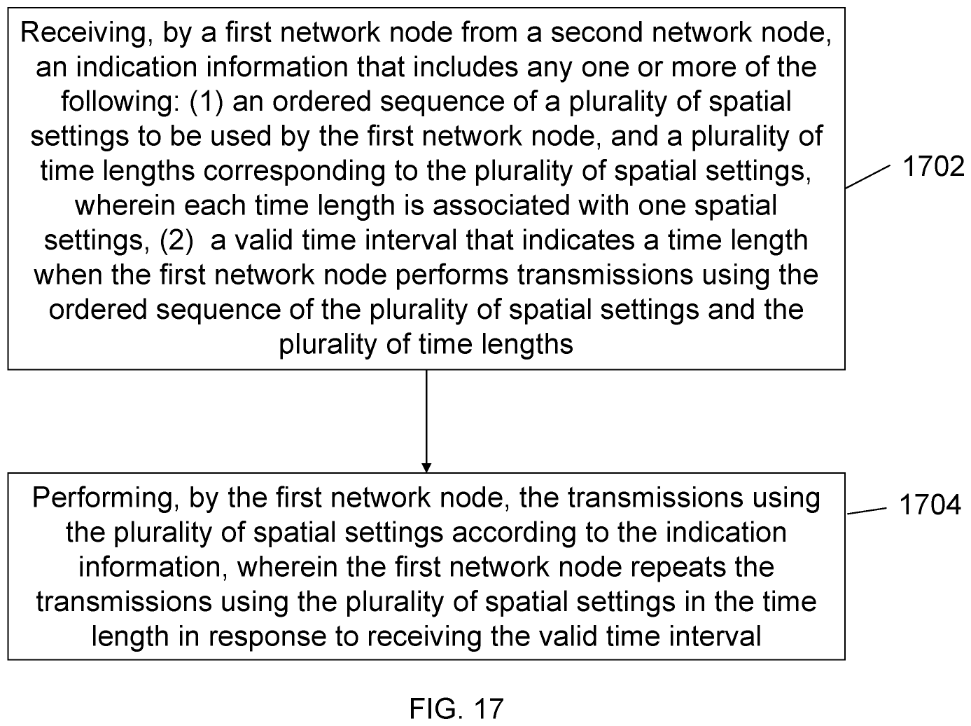

FIG. 17 shows an exemplary flowchart for a wireless communication method. Operation 1702 includes receiving, by a first network node from a second network node, an indication information that includes any one or more of the following: (1) an ordered sequence of a plurality of spatial settings to be used by the first network node, and a plurality of time lengths corresponding to the plurality of spatial settings, wherein each time length is associated with one spatial settings, (2) a valid time interval that indicates a time length when the first network node performs transmissions using the ordered sequence of the plurality of spatial settings and the plurality of time lengths. Operation 1704 includes performing, by the first network node, the transmissions using the plurality of spatial settings according to the indication information, wherein the first network node repeats the transmissions using the plurality of spatial settings in the time length in response to receiving the valid time interval.

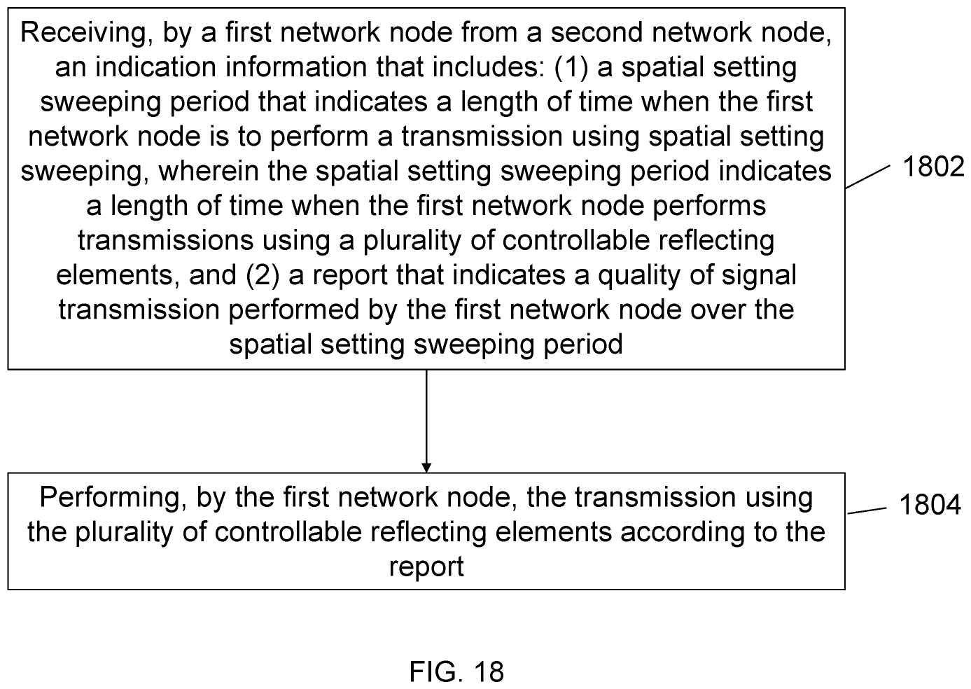

FIG. 18 shows an exemplary flowchart for a wireless communication method. Operation 1802 includes receiving, by a first network node from a second network node, an indication information that includes: (1) a spatial setting sweeping period that indicates a length of time when the first network node is to perform a transmission using spatial setting sweeping, wherein the spatial setting sweeping period indicates a length of time when the first network node performs transmissions using a plurality of controllable reflecting elements, and (2) a report that indicates a quality of signal transmission performed by the first network node over the spatial setting sweeping period. Operation 1804 includes performing, by the first network node, the transmission using the plurality of controllable reflecting elements according to the report.

In some embodiments, the spatial setting sweeping period is configured by a base station (BS) or an operation, administration, and management (OAM) node. In some embodiments, the report indicates the quality of signal transmission for each of a plurality of time units within the spatial setting sweeping period. In some embodiments, the report indicates that the quality of signal transmission is high during a number of time interval, wherein each time interval is identified by a first time when a time interval starts and a second time when the time interval ends. In some embodiments, the report indicates that the quality of signal transmission is high during a number of time interval, wherein each time interval is identified by a time when a time interval starts and a length of time of the time interval. In some embodiments, the second network node includes a base station (BS), and wherein the communication node includes a user equipment (UE).

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
receiving, by a first network node from a second network node, a configuration information that indicates information about a number of spatial settings configured for the first network node,
wherein each of the number of spatial settings corresponds to a spatial domain filter used by the first network node to communicate with one or more communication nodes.

2. The method of claim 1, wherein the first network node transmits a maximum number of spatial settings supported by the first network node to the second network node prior to the receiving the configuration information.

3. The method of claim 1,
wherein the configuration information includes a bitmap indicating the number of spatial settings to be used by the first network node to communicate with a communication node, and
wherein each bit in the bitmap indicates that a corresponding spatial setting is either enabled or disabled in communication with the communication node.

4. The method of claim 1, wherein the number of spatial settings is configured by a base station (BS) or an operation, administration, and management (OAM) node.

5. The method of claim 1, further comprising:
performing, by the first network node, communication with the one or more communication nodes by using a spatial setting from the number of spatial settings according to the configuration information.

6. The method of claim 5,
wherein the performing the communication includes transmitting to a communication node information using the spatial setting, and
wherein the information is received by the first network node from the second network node prior to the transmitting.

7. The method of claim 5,
wherein the performing the communication includes receiving from a communication node information using the spatial setting, and
wherein the first network node sends to the second network node the information received from the communication node.

8. A wireless communication method, comprising:
receiving, by a communication node from a second network node, a configuration information that include:
a bitmap corresponding to one or more reference signals,
a number of spatial settings that are configured for a first network node, and
a number of forwarding gaps associated with one or more reference signal.

9. The method of claim 8, wherein the bitmap includes one or more bits, wherein each bit corresponds to one reference signal, and wherein each bit indicates to the communication node whether a reference signal is to be received by the communication node from the second network node via the first network node.

10. The method of claim 8, wherein the configuration information indicates the number of spatial settings associated with each of the one or more reference signals that are to be received by the communication node from the second network node via the first network node.

11. The method of claim 8,
wherein the configuration information indicates a forwarding gap when a first network node does not send to the communication node information from the second network node,
wherein the forwarding gap indicates a length of time when the communication node receives the one or more reference signals from the second network node and does not receive the one or more reference signals from the first network node, and
wherein the method comprises receiving, by the communication node, the one or more reference signals from the second network node during the forwarding gap and the one or more reference signals from the first network node during a time other than the forwarding gap.

12. The method of claim 8, wherein the configuration information includes a value for the forwarding gap associated with each of the one or more reference signals that are not to be received by the communication node from the second network node during the forwarding gap.

13. The method of claim 8, wherein the configuration information is received in a system information (SI).

14. The method of claim 8, further comprising:
receiving, by the communication node, information from the first network node using a spatial setting from the number of spatial settings, wherein the information is received by the communication node from the second network node via the first network node.

15. The method of claim 8, wherein the one or more reference signals includes one or more synchronization signal blocks (SSBs).

16. A wireless communication method, comprising:
receiving, by a first network node from a second network node, an indication information that includes any one or more of the following:
(1) an ordered sequence of a plurality of spatial settings to be used by the first network node, and a plurality of time lengths corresponding to the plurality of spatial settings, wherein each time length is associated with one spatial settings,
(2) a valid time interval that indicates a time length when the first network node performs transmissions using the ordered sequence of the plurality of spatial settings and the plurality of time lengths; and
performing, by the first network node, the transmissions using the plurality of spatial settings according to the indication information,
wherein the first network node repeats the transmissions using the plurality of spatial settings in the time length in response to receiving the valid time interval.

17. A wireless communication method, comprising:
receiving, by a first network node from a second network node, an indication information that includes:
(1) a spatial setting sweeping period that indicates a length of time when the first network node is to perform a transmission using spatial setting sweeping, wherein the spatial setting sweeping period indicates a length of time when the first network node performs transmissions using a plurality of controllable reflecting elements, and
(2) a report that indicates a quality of signal transmission performed by the first network node over the spatial setting sweeping period; and
performing, by the first network node, the transmission using the plurality of controllable reflecting elements according to the report.

18. The method of claim 17, wherein the spatial setting sweeping period is configured by a base station (BS) or an operation, administration, and management (OAM) node.

19. The method of claim 17, wherein the report indicates the quality of signal transmission for each of a plurality of time units within the spatial setting sweeping period.

20. The method of claim 17, wherein the report indicates that the quality of signal transmission is high during a number of time interval, wherein each time interval is identified by a first time when a time interval starts and a second time when the time interval ends or wherein each time interval is identified by a time when a time interval starts and a length of time of the time interval.
